(19) United States
(12) Patent Application Publication
(10) Pub. No.: US 2014/0097061 A1
(43) Pub. Date: Apr. 10, 2014

(54) CLUTCH ACTUATION SYSTEM

(71) Applicant: ZF Friedrichshafen AG, Friedrichshafen (DE)

(72) Inventors: Kai BORNTRAEGER, Langenargen (DE); Thorsten LEIM, Friedrichshafen (DE)

(73) Assignee: ZF Friedrichshafen AG, Friedrichshafen (DE)

(21) Appl. No.: 14/048,184

(22) Filed: Oct. 8, 2013

(30) Foreign Application Priority Data
Oct. 10, 2012 (DE) 10 2012 218 472.4

(51) Int. Cl. F16D 23/12

(52) U.S. Cl. CPC F16D 23/12
USPC 192/99 S

(57) ABSTRACT

A device and a method for rapid disengagement of a clutch (2). The device has a mechanical transmission path (26) which is arranged between a clutch actuator (12) and a first clutch part and comprises a knee lever (4) which facilitates rapid disengagement of the clutch (2).

This application claims priority from German patent application serial no. 10 2012 218 472.4 filed Oct. 10, 2012.

### FIELD OF THE INVENTION

The present invention relates to a device for the rapid disengagement of a clutch, and to a method for the rapid disengagement of a clutch.

### BACKGROUND OF THE INVENTION

Today it is generally known that, in the majority of motor vehicles, a clutch is installed between the engine and the transmission in the form of a friction clutch for start-up and for switching the gear stages. In this case, clutches function as a detachable connection between the engine and the transmission. The shiftable clutch makes it possible to comfortably start up an internal combustion engine-driven motor vehicle from a standstill. The clutch transfers the engine torque to the transmission input shaft in a force-locking manner by means of frictional forces and enables the torque flow to be disengaged rapidly and completely and then smoothly re-engaged in the start-up procedure and in the shifting procedure. Therefore, it is important for the clutch to be designed such that this transfers the maximum amount of input torque produced in a sufficiently reliable manner.

Automatic transmissions are also used in most motor vehicles. A friction clutch, as the engine clutch, is assigned to the particular automatic transmission on the drive side, wherein the friction clutch is also automatic and is usually designed as a single-disk dry clutch, and is automatically engaged or disengaged by an assigned clutch actuator in start-up and shifting procedures. So-called semi-automatic transmissions are also known, in which gears are shifted manually and the engine clutch is automatically engaged and disengaged by means of a clutch actuator.

High requirements are placed on the clutch in terms of increasing the load in a soft, smooth manner. This requires that the pressure plate and the mechanical transmission path (levers, springs, etc.) move slowly and uniformly, which typically takes place in automatic transmissions by means of an electrically-, hydraulically- or pneumatically-operated clutch actuator. This is contrasted by requirements that the drive train be disengaged very rapidly in the event of a very rapid braking procedure (full braking). Since the drive train must be disengaged rapidly in the event of full braking, the load on the engine must be relieved to prevent the engine from stalling. In addition, the engine must not induce a reaction on the output drive, e.g. in the form of pushing in the event of rapid braking at low driving speeds.

Document DE 10 2005 055 210 A1, which belongs to the applicant, discloses an automatic transmission having a servo drive and a friction clutch, which is intended to improve control behavior in the event of a rapid change in the direction of motion, wherein the design must also be simple and inexpensive. The problem was solved by a servo drive, which is formed as a pneumatic muscle having a tubular body made of a fluid-tight and elastic material, having a mesh, which is made of non-extending fibers and is disposed in the outer region on the tubular body, and having end pieces which close the axial ends of the tubular body. The pneumatic muscle, having great actuating power and a rapid response characteristic, is particularly suitable for use with a clutch actuator of an automatic engine clutch that is designed as a dry clutch and is actuated by means of a release lever via a release bearing, which acts against a contact pressure spring (diaphragm spring). In this case, the pneumatic muscle is expediently disposed on the tension side of the release lever, oriented substantially parallel to the direction of motion of the release bearing, having the lever-side end piece thereof, connected to the release lever in an articulated manner, and having the end piece facing away from the lever attached to the housing. In this case, the actuating path of the pneumatic muscle extends, with corresponding leverage, between the friction clutch as completely engaged in the non-operative state and as completely disengaged. Pneumatic servo drives are difficult to control, however, due to the friction and compressibility thereof.

### SUMMARY OF THE INVENTION

Proceeding therefrom, the problem addressed by the present invention is that of providing a device and a method for the rapid disengagement of a clutch, which permits rapid disengagement of the clutch in the event of a hard braking procedure and which can be used with dry clutches as well as wet clutches.

This problem is solved with respect to the device for the rapid disengagement of a clutch on the basis of the features described herein, and with respect to a method for the rapid disengagement of a clutch as described herein.

The problem is solved by means of a device for the rapid disengagement of a clutch, wherein a mechanical transmission path is provided between a clutch actuator and a first clutch part having a knee lever. The clutch actuator is an actuator that disengages and engages the clutch. To this end, at least a portion of the actuator can move in the disengagement direction or in the engagement direction of the clutch. The knee lever is integrated in the connecting path between the clutch actuator and the clutch. A knee lever is understood to be a component that comprises two legs, which are connected to one another, and has rotation points at the connection points. The knee lever according to the invention is connected to the clutch actuator via a first rotation point by means of a first end of the first leg of this knee lever, and is connected to a first coupling part via a second rotation point by means of a first end of the second leg of this knee lever, The two legs are also connected to one another at the respective second ends of the legs via a third rotation point. In addition, the knee lever according to the invention is equipped with a tension spring, which is attached at the first rotation point of the first leg and at the first rotation point of the second leg and tensions the knee lever in the extended position thereof. If the knee lever is deflected out of the extended position thereof in which the two legs thereof form a virtually straight line, the knee lever is drawn together by means of the spring force, and so the two first rotation points move toward one another. In the extended position, the knee lever is over-extended. Therefore, the knee lever is moved beyond the dead-center position until the knee lever undergoes an automatic locking effect by means of a mechanical stop. The tension force remains even if the actuating force that deflected the knee lever beyond the dead-center position diminishes, wherein this tension force cannot become released on its own, even in the event of vibrations and fluctuating loads. Optionally, a securing element can be provided that holds the knee lever in the extended position.

If the command is issued to rapidly disengage the drive train, i.e. to rapidly disengage the clutch, the knee lever is deflected beyond the dead-center position. The device for triggering the deflection can undergo a linear motion or a rotational motion, e.g. by means of eccentrics, cylinders or servo drives. No requirements in terms of control quality are placed on the release device, which can be operated in an electrical, hydraulic or pneumatic manner. Only two positions are required. One position for triggering the rapid disengagement and one position to prevent triggering. The knee lever is tensioned by means of the tension spring; after triggering, the clutch is disengaged very rapidly. Parallel therewith, or after the rapid disengagement procedure, the coupling actuator can also move in the disengagement direction. The knee lever is re-extended by means of this disengagement motion of the actuator and, once a return position is reached, with the knee lever fully extended, the knee lever is deflected by means of a pressure piece beyond the dead-center position in the direction of locking. If the coupling actuator is now moved in the direction of the engaged clutch, the system returns to the starting position. The dynamics of the coupling actuator itself therefore become very inconsequential and it is therefore possible to optimize the coupling actuator in terms of control quality and costs.

The release device should be activated only in certain situations, in which rapid disengagement of the clutch is desired, such as in the event of full braking. Therefore, the release device must be controlled in such a way that these driving situations are detected, which can be achieved, for example, by detecting a hard braking procedure by measuring the engine speed of the motor vehicle or by means of a signal of the antilock braking system. The signals are registered by a control device that controls the release device. An already existing control device can also be used as the control device.

### BRIEF DESCRIPTION OF THE DRAWINGS

An exemplary embodiment is shown in three functional positions in three figures in the drawings in order to illustrate the invention.

FIG. 1: shows the device according to the invention, with the clutch engaged

FIG. 2: shows the device according to FIG. 1, with the “rapidly disengaged” clutch according to the invention

FIG. 3: shows the device according to FIG. 1 with the clutch disengaged and the actuator in the return position

### DETAILED DESCRIPTION OF THE PREFERRED EMBODIMENTS

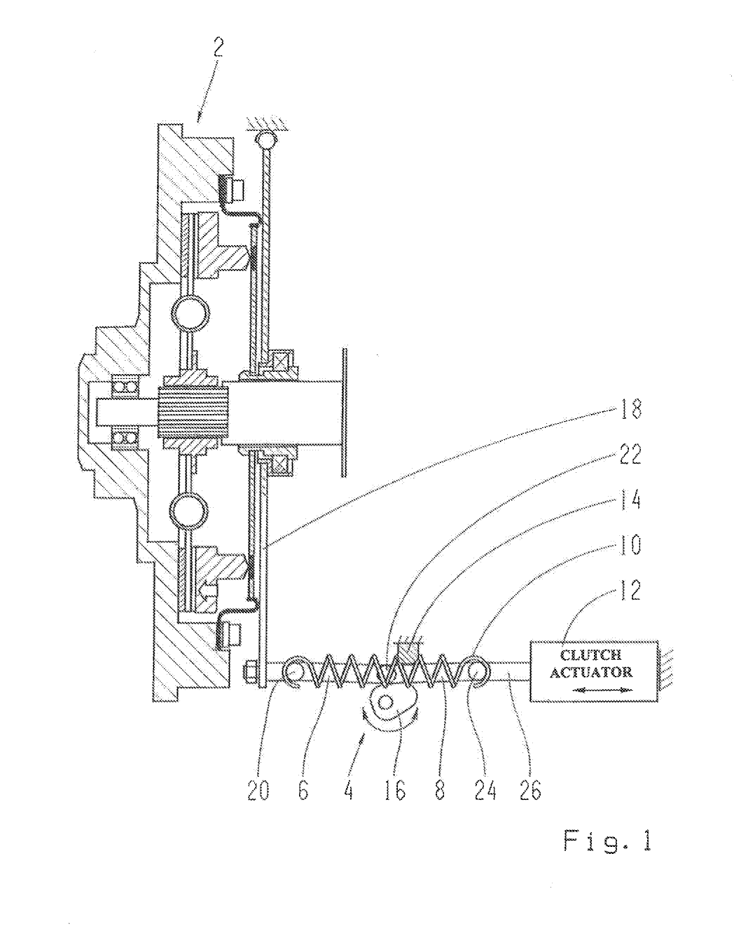

FIG. 1 shows a device according to the invention with the clutch 2 engaged. The knee lever 4 is in the extended state, in which the two legs 6, 8 and the three rotational points 20, 22, 24 form a virtually straight line. The knee lever is tensioned by means of a tension spring 10. The two legs 6, 8 of the knee lever 4 are opened beyond the dead-center position, reaching a non-illustrated mechanical stop functioning as a lock, and are held in this position by means of the spring force of the tension spring 10. For safety, an additional, optional securing element 14 is installed here, which prevents the leg 8 and, therefore, the knee lever 4 from opening without being released by a release device 16. The release device 16 is designed as an eccentric in this case, which can deflect the knee lever 4 by means of a rotational motion. In this position, the knee lever 4 therefore does not affect the clutch 2 or the clutch actuator 12, and the clutch actuator 12 actuates the clutch 2 by moving to the left, in the engagement direction, in the direction of the clutch 2, in order to thereby press the release fork 18 against the clutch 2 via the mechanical transmission path 26 with the knee lever 4, thereby engaging the clutch 2.

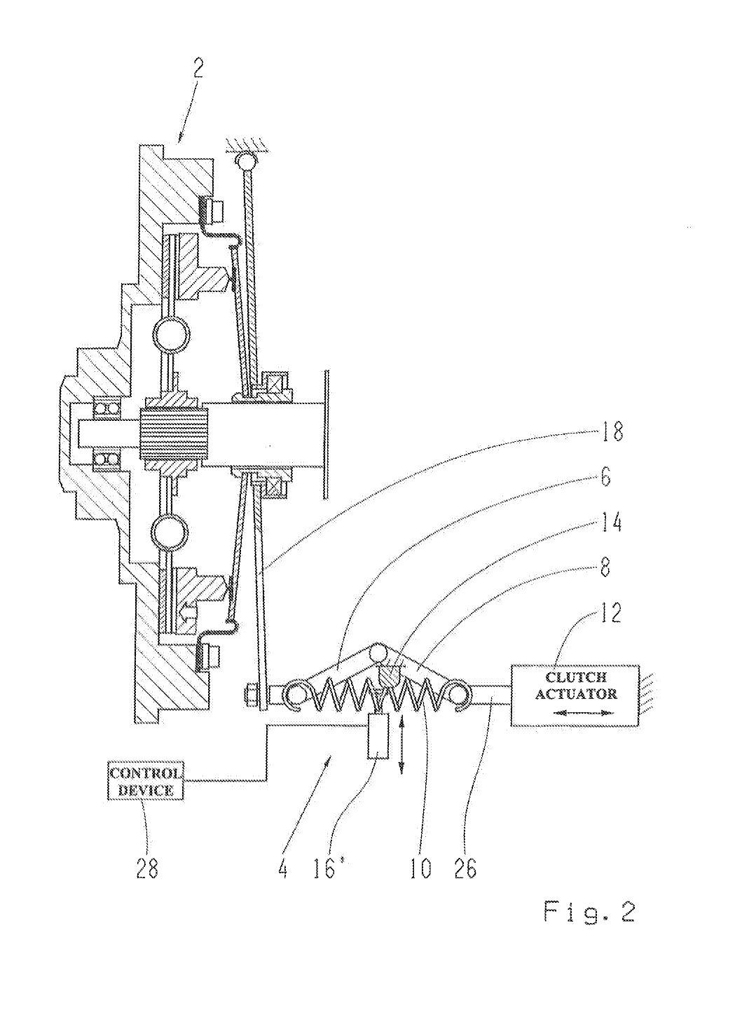

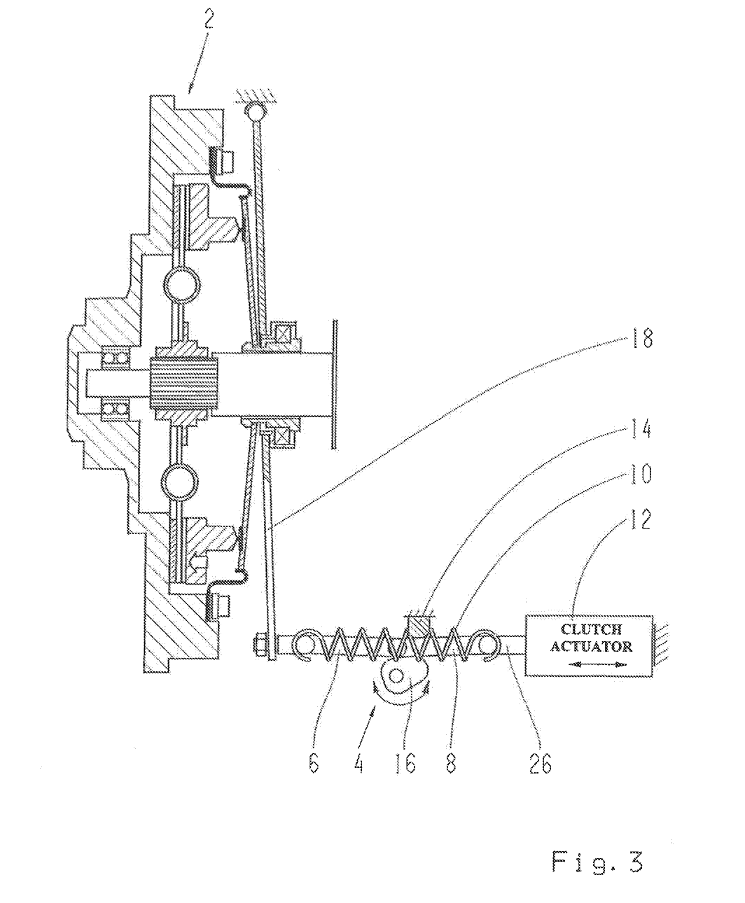

FIG. 2 shows a device according to the invention with the clutch 2 disengaged, wherein rapid disengagement takes place in this case with the aid of the knee lever 4. A driving situation having a hard braking procedure is detected, whereupon the release device 16′ is activated by a control device 28. This example shows a release device 16′ that deflects the knee lever 4 by means of a linear motion. The knee lever 4 is pressed past the securing element 14 and is drawn together very rapidly by means of the spring force of the tension spring 10. Therefore, the release fork 18 is drawn away from the clutch 2 and the clutch 2 is disengaged. The clutch actuator 12 can move, in parallel therewith or after the disengagement procedure of the knee lever, out of a first, left end position, in the disengagement direction, to the right, away from the clutch 2. As a result, the knee lever 4 is extended and is drawn back into the extended state thereof. This is depicted in FIG. 3.

In FIG. 3, the clutch actuator 12 is located in the right end position thereof and has extended the knee lever 4 to the extent that the knee lever was pressed past the securing element 14 and, therefore, is opened beyond the dead-center point, to the stop. The clutch 2 can now be engaged once more by means of the clutch actuator 12, in that the clutch actuator 12 is moved out of the second, right end position thereof to the left, in the direction of the clutch 2.

### REFERENCE CHARACTERS

2 clutch
4 knee lever
6 leg of the knee lever
8 leg of the knee lever
10 tension spring
12 clutch actuator
14 securing element
16 release device (rotational motion)
16′ release device (linear motion)
18 release fork
20 rotational point
22 rotational point
24 rotational point
26 mechanical transmission path
28 control device

1-10. (canceled)

11. A device for rapid disengagement of a clutch (2), the device comprising:
a mechanical transmission path (26) located between a clutch actuator (12) and a first clutch part, and
the mechanical transmission path (26) comprising a knee lever (4).

12. The device for the rapid disengagement of a clutch (2) according to claim 11, wherein the knee lever (4) is connected to a spring (10).

13. The device for the rapid disengagement of a clutch (2) according to claim 11, wherein the knee lever (4) is equipped with a lock.

14. The device for the rapid disengagement of a clutch (2) according to claim 13, wherein the lock comprises a mechanical stop,

15. The device for the rapid disengagement of a clutch (2) according to claim 13, wherein a securing element (14) abuts and locks the knee lever (4).

16. The device for the rapid disengagement of a clutch (2) according to claim 13, wherein a release device (16, 16′) communicates with the knee lever and is actuatable so as to deflect the knee lever (4).

17. A method of rapidly disengaging a clutch (2) with a disengagement device comprising a mechanical transmission path (26) which is located between a clutch actuator (12) and a first clutch part and comprises a knee lever (4), the method comprising the steps of:
fixing a spring at ends of the knee lever; and
upon detection of a hard braking procedure, deflecting an extended knee lever (4) out of a locked position with a release device (16, 16′) such that the spring (10) moves the ends of the knee lever (4) toward one another, by a force of the spring so as to enable the rapid disengagement of the clutch (2).

18. The method of rapidly disengaging the clutch (2) according to claim 17, further comprising the step of actuating the clutch actuator, either simultaneously with or after the rapid disengagement of the clutch, to move out of a first end position in a disengagement direction and, in a second end position, extends the knee lever (4), which is deflected by a pressure piece beyond a dead-center position to a mechanical stop, and so the knee lever (4) reaches the extended starting position thereof.

19. The method of rapidly disengaging the clutch (2) according to claim 17, further comprising the step of moving the release device (16, 16′) in either a linear manner or a rotational manner.

20. The method of rapidly disengaging the clutch (2) according to claim 17, further comprising the step of detecting the hard braking procedure either by measuring engine speed of the motor vehicle or by a signal from an antilock braking system.

21. A device for rapid disengagement of a clutch (2), the device comprising:
a mechanical transmission path (26) being located between and coupling a clutch actuator (12) with a first clutch part,
the mechanical transmission path (26) comprising a knee lever (4), and the knee lever (4) having a folded position which facilitates rapid disengagement of the clutch (2) and an extended position which facilitates engagement of the clutch (2).
